(19) United States
(12) Patent Application Publication
(10) Pub. No.: US 2018/0055723 A1
(43) Pub. Date: Mar. 1, 2018

(54) MASSAGE BALL SYSTEMS

(71) Applicant: Debra Bick, New York, NY (US)

(72) Inventor: Debra Bick, New York, NY (US)

(21) Appl. No.: 15/250,946

(22) Filed: Aug. 30, 2016

(51) Int. Cl. A61H 15/00

(52) U.S. Cl. CPC A61H 15/0092; A61H 2015/005

(57) ABSTRACT

A massage ball system for self-massage is disclosed herein. The system includes assembly for self-massage that is usable by a single individual in order to relieve stress anywhere the user may need to without requiring the aid of another person. The massage ball system has at least two balls attached using a rope or the like, and all covered in a soft feeling material. The balls can be used on a variety of pressure points, emulating the same effect as a deep tissue massage.

### BACKGROUND OF THE INVENTION

The following includes information that may be useful in understanding the present disclosure. It is not an admission that any of the information provided herein is prior art, or material, to the presently described or claimed inventions, or that any publication or document that is specifically or implicitly referenced is prior art.

### 1. Field of the Invention

The present invention relates generally to the field of massage devices and more specifically relates to a personal massager.

### 2. Description of Related Art

Massage involves working and acting on the body with pressure which is either structured, unstructured, stationary, or moving, and may be completed with tension, motion, or vibration, done manually or with mechanical aids. Massage can be applied with the hands, fingers, elbows, knees, forearm, feet, or a massage device. Massage can promote relaxation and well-being. Massaging devices for increasing blood circulation and stimulating the skin and underlying tissue are well known.

Hand held massaging devices provide a stimulating effect by rolling a textured cylindrical or other shaped member along the area to be massaged such as an arm or leg. Generally, to get the most benefit out of the existing massagers it is necessary for a second person to use the device on the person being massaged. This is especially true if the area being massaged is relatively inaccessible to the person being massaged, such as the small of the back.

Existing hand held massagers are much less effective if there is no second person giving the massage and an individual chooses to give him or herself a massage. Further, these devices do not allow the user to easily apply any more pressure than he or she can exert with arm muscles, which in some cases may be insufficient to stimulate deep tissue below the skin. A suitable solution is desired.

Several attempts have been made to solve the above-mentioned problems such as those found in US Pat. App. Pub. No. 2011/0071446 to Stuart Citrin, U.S. Pat. No. 5,868,689 to Sherri Faroky et al., and US Pat. App. Pub. No. 2003/0009118 to Raymond Sabo et al. This art is representative of massage devices. However, none of the above references, taken either singly or in combination, is seen to disclose the invention as claimed.

Preferably, a massage device should provide an efficient way to massage areas of the body without the aid of a second person, and yet, would operate reliably and be manufactured at a modest expense. Thus, a need exists for a reliable massage system to avoid the above-mentioned problems.

### BRIEF SUMMARY OF THE INVENTION

In view of the foregoing disadvantages inherent in the known massage device art, the present invention provides a novel massage ball system. The general purpose of the present invention, which will be described subsequently in greater detail is to provide a way to massage areas of the body without the aid of a second person. The massage ball system permits a user to access pressure points anywhere on their body for stress relief and relaxation.

A massage ball system is disclosed in a preferred embodiment comprising an assembly for self-massage, the assembly may include a rope (or rope-like structure) having a first grabbing end, a second grabbing end, and a length, the length extending between the first grabbing end and the second grabbing end, the rope including a durable braided segment, a plurality of balls connected to the rope, each of the plurality of balls having a compressibility, an outer surface, an inner volume, and a circumference, respectively. The compressibility of the plurality of balls is compressible by hand. The plurality of balls may include two or more tennis-like balls, wherein at least one of the plurality of balls may have an oblong shape.

Each of the plurality of balls includes a center and a rope passage, the rope passage goes through two opposing sides of the outer surface and through the center. Each of the plurality of balls may have a solid construction. The compressibility of each of the plurality of balls may be variable and selectable by the user. The rope extends through each rope passage of each of the plurality of balls, respectively. The pressure of the plurality of balls promotes deep tissue relief, and at least one of the plurality of balls is fixed to a point along the length of the rope. The length of rope may be arm's length or may be approximately five feet in length, with a fabric cover having a silky texture that is soft to the skin of a user, and the fabric cover substantially envelops the length of the rope and the plurality of balls. Further, the fabric cover may be substantially similar to mink with a low pile.

The rope and the plurality of balls are configured to apply massage pressure to one or more parts of the user via the outer surfaces of the plurality of balls when an opposing tensile force is applied to each end of the rope as a result of the first grabbing end and the second grabbing end of the rope, and the rope being pulled toward the user. The fabric covers the assembly for self-massage, and the entire assembly is used to provide a tool for self massage by a single user for massaging a part of the single user's body. The massage ball system is also disclosed configured as a kit including: an assembly for self-massage, and a set of user instructions.

The present invention may hold significant improvements and serves as a massage ball system. For purposes of summarizing the invention, certain aspects, advantages, and novel features of the invention have been described herein. It is to be understood that not necessarily all such advantages may be achieved in accordance with any one particular embodiment of the invention.

Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, massage ball systems, constructed and operative according to the teachings of the present disclosure.

FIG. 1 shows a side view illustrating a massage ball system during an ‘in-use’ condition, showing a user leaning on the assembly for self-massage, according to an embodiment of the present disclosure.

FIG. 2 is a perspective view illustrating the massage ball disassembled, according to an embodiment of the present disclosure.

FIG. 3 is a perspective view illustrating the massage ball system fully assembled, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present invention relate to a massage device and more particularly to a massage ball system as used to improve the ability for a person to self-massage. Accordingly, the assembly for self-massage may be usable by a single individual for self-massage in order to relieve stress/tension in muscle groups anywhere the user may need this relief, without requiring the aid of a second individual.

Generally speaking, the disclosed massage ball systems may comprise two tennis-like balls attached to a piece of rope, covered in a soft fabric. Other personal massage tools are too heavy because they rely on motors, and are typically battery operated. The massage ball system may also be used in vehicles at the small of the back in the seat to relieve stress while driving. The massage ball system helps a person massage the point of origin and point of insertion on a muscle similar to a massage therapist using two hands. Preferably, the balls will fit snugly over the rope in order to function without too much movement.

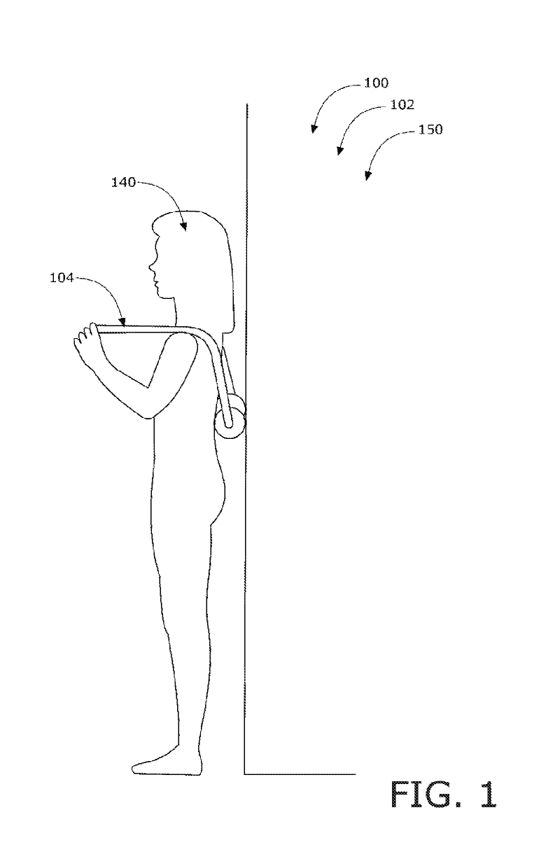

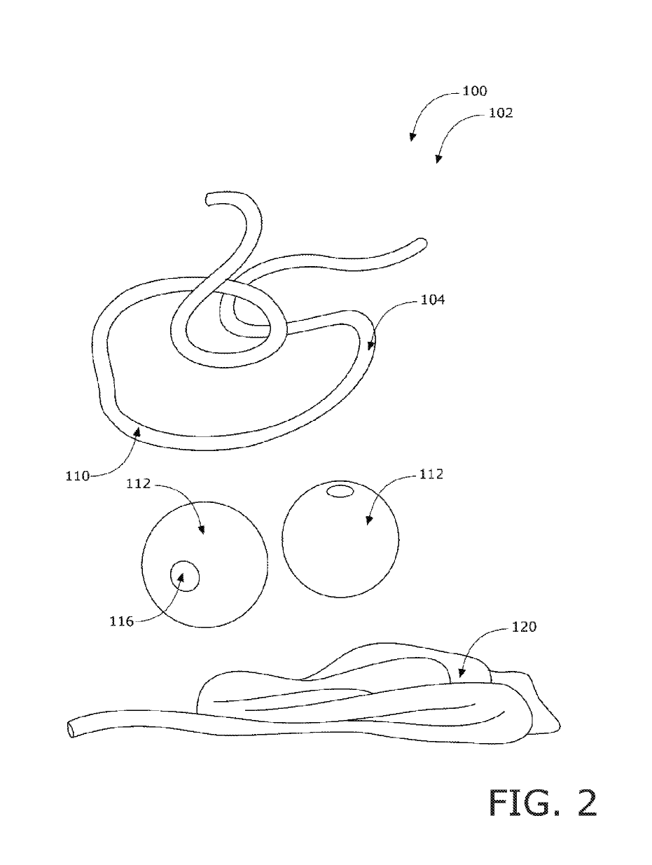

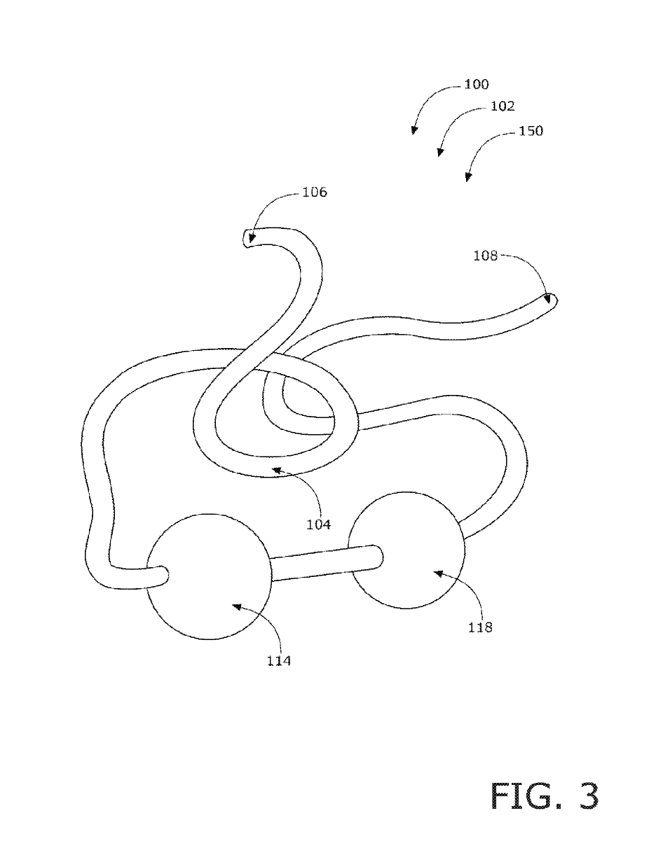

Referring to the drawings by numerals of reference, there is shown in FIGS. 1-4 massage ball system 100 according to an embodiment of the present disclosure. Massage ball system 100 may include an assembly for self-massage 102, which may include a rope 104 having a first grabbing end 106, a second grabbing end 108, and a length 110. The length 110 extends between the first grabbing end 106 and the second grabbing end 108. The rope 104 may include a durable braided segment. The massage ball system 100 also includes a plurality of balls 112 connected to rope 104, with each of plurality of balls 112 having a compressibility, outer surface 114, inner volume 116, and circumference 118, respectively. The massage ball system 100 also includes a fabric cover 120, which may have a silky texture that is soft to a skin of user 140. The fabric cover 120 substantially envelopes the length 110 of rope 104 and the plurality of balls 112. This may be together or individually.

The rope 104 and plurality of balls 112 are configured to apply a massage pressure to one or more parts of user 140 via the outer surfaces 114 of plurality of balls 112 when an opposing tensile force is applied to each end of rope 104, and first grabbing end 106 and second grabbing end 108 of rope 104 are pulled toward user 140. For example, when the rope 104 is taut and pulled by the user 140 toward a part of the user's body the body's resistive force is applied to just the plurality of balls 112, as the rope 104 is suspended away from the body. Moreover, the primary (if not only) contact with the massage ball system 100 is with the outer surface 114 of each of the plurality of balls 112, applying discrete massage pressure to one or more parts of said user 140. Moreover, the user 140 has full control over the amount of force applied. This may be particularly beneficial where a pain point is suddenly experienced. Finally, the compressive quality of each of the plurality of balls 112 may be selected to limit applied pressure to the user's tastes. For example, as a tennis-like ball, the compressibility will be broadly defined as the compressibility of a standard tennis ball when compressed by hand. Also for example, the compressibility may be broadly defined to include at least a 1% deflection when pressures in the human range of grip are applied. Greater and lesser compressibilities, according to the requirements of the user 140 are contemplated.

Fabric cover 120 surrounds the assembly for self-massage, and the entire assembly may be used provide a tool for self-massage by the single user, and for massaging a part of the single user's 140 body. The compressibility of plurality of balls 112 is compressible by hand. According to one embodiment, the plurality of balls 112 may include three or more tennis-like balls. According to one embodiment, the plurality of balls 112 may be smaller than tennis balls. According to another embodiment, the plurality of balls 112 may be larger than tennis balls. Each of the plurality of balls 112 includes a center and rope passage. The rope passage goes through two opposing sides of outer surface 114, and through the ball's center. The rope 104 extends through each rope passage of each of plurality of balls 112, respectively, such that the balls are strung. At least one of plurality of balls 112 may be fixed to a point along length 110 of rope 104. Beneficially, when in use 150, applied pressure from the plurality of balls 112 may promote deep tissue relief.

According to embodiments, the length 110 of rope 104 may be broadly a range of “arms-length” (e.g., 4 feet to 8 feet), may be less than five feet in length 110, may be approximately five feet in length 110, or alternatively may be more than five feet in length 110. Fabric cover 120 may be substantially similar to chenille with a low pile, substantially similar to crepe de chine with a low pile, or alternatively substantially similar to mink with a low pile. Each of plurality of balls 112 may have a hollow construction. Alternatively, each of plurality of balls 112 may have a solid construction. The compressibility of each of plurality of balls 112 may be variable and selectable by user 140. Further, at least one of plurality of balls 112 may have an oblong shape.

It should be noted that massage ball system 100 may be sold as a kit including at least one self-massage assembly 102 and at least one set of user instructions. The kit has instructions such that functional relationships are detailed in relation to the structure of the massage ball system 100 (such that the massage ball system 100 can be used, maintained, or the like in a preferred manner). Massage ball system 100 may be manufactured and provided for sale in a wide variety of sizes and shapes for a wide assortment of applications.

Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An assembly for self-massage, the assembly comprising:
a rope having a first grabbing end, a second grabbing end, and a length, the length extending between the first grabbing end and the second grabbing end, the rope including a durable braided segment;
a plurality of balls connected to said rope, each of the plurality of balls having a compressibility, an outer surface, an inner volume, and a circumference, respectively;
a fabric cover having a silky texture that is soft to a skin of a user, said fabric cover substantially enveloping said length of said rope and said plurality of balls;
wherein said rope and said plurality of balls are configured to apply a massage pressure to one or more parts of said user via the outer surfaces of said plurality of balls when an opposing tensile force is applied to each end of said rope, and said first grabbing end and said second grabbing end of the rope are pulled toward said user; and
wherein said rope, said plurality of balls, and said fabric cover are arranged as a tool for self-massage usable by said user for massaging said one or more parts of said user's body.

2. The assembly of claim 1, wherein each compressibility of each of said plurality of balls is compressible by hand.

3. The assembly of claim 2, wherein said plurality of balls includes three or more tennis-like balls.

4. The assembly of claim 2, wherein said plurality of balls are smaller than tennis balls.

5. The assembly of claim 2, wherein said plurality of balls are larger than tennis balls.

6. The assembly of claim 1, wherein each of said plurality of balls includes a center and a rope passage, said rope passage going through two opposing sides of the outer surface through said center; and
wherein said rope to extends through each rope passage of each of said plurality of balls, respectively.

7. The assembly of claim 1, wherein at least one of said plurality of balls is fixed to a point along the length of said rope.

8. The assembly of claim 1, wherein said length of said rope is less than five feet in length.

9. The assembly of claim 1, wherein said length of rope is approximately five feet in length.

10. The assembly of claim 1, wherein said length of rope is between four feet in length and seven feet in length.

11. The assembly of claim 1, wherein said fabric cover is substantially similar to chenille with a low pile.

12. The assembly of claim 1, wherein said fabric cover is substantially similar to crepe de chine with a low pile.

13. The assembly of claim 1, wherein said fabric cover is substantially similar to mink with a low pile.

14. The assembly of claim 1, wherein each of said plurality of balls has a hollow construction.

15. The assembly of claim 1, wherein each of said plurality of balls has a solid construction.

16. The assembly of claim 1, wherein said compressibility of each of said plurality of balls is variable and selectable by said user.

17. The assembly of claim 1, wherein at least one of said plurality of balls has an oblong shape.

18. An assembly for self-massage, the assembly comprising:
a rope having a first grabbing end, a second grabbing end, and a length, the length extending between the first grabbing end and the second grabbing end;
a plurality of balls connected to said rope, each of the plurality of balls having a compressibility, an outer surface, an inner volume, and a circumference, respectively;
a fabric cover substantially similar to mink with a low pile, said fabric cover substantially enveloping said length of said rope and said plurality of balls;
wherein each compressibility of said plurality of balls is compressible by hand;
wherein said plurality of balls includes at least one tennis-like ball;
wherein at least one of said plurality of balls has an oblong shape;
wherein each of said plurality of balls includes a center and a rope passage, said rope passage going through two opposing sides of the outer surface through said center;
wherein said compressibility of each of said plurality of balls is variable and selectable by said user;
wherein said rope to extends through each rope passage of each of said plurality of balls, respectively;
wherein at least one of said plurality of balls is fixed to a point along the length of said rope;
wherein said length of rope is approximately five feet in length;
wherein said rope and said plurality of balls are configured to apply a massage pressure to one or more parts of said user via the outer surfaces of said plurality of balls when an opposing tensile force is applied to each end of said rope, and said first grabbing end and said second grabbing end of the rope are pulled toward said user; and
wherein said rope, said plurality of balls, and said fabric cover are arranged as a tool for self-massage usable by said user for massaging said one or more parts of said user's body.

19. The assembly of claim 18 further comprising a set of user instructions; and wherein the assembly is arranged as a kit.
